(19) United States
(12) Patent Application Publication
(10) Pub. No.: US 2004/0151640 A1
(43) Pub. Date: Aug. 5, 2004

(54) Reactor for gas/ liquid or gas/ liquid/solid reactions

(76) Inventors: Regina Benfer, Altrip (DE); Michael Nilles, Bobenheim-Roxheim (DE); Werner Weinle, Friedelsheim (DE); Peter Zehner, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/475,723

(22) PCT Filed: Apr. 26, 2002
(86) PCT No.: PCT/EP02/04653

(30) Foreign Application Priority Data
Apr. 27, 2001 (DE) 101208014

(51) Int. Cl. B01J 10/00

(52) U.S. Cl. 422/129; 422/149

(57) ABSTRACT

A reactor (1) having a vertical longitudinal axis and an inlet (2) for a liquid or liquid/solid feed stream in the upper region of the reactor and an inlet (3) for a gaseous stream in the lower region of the reactor (1), characterized by

at least two chambers (4) arranged above one another in the longitudinal direction, where

the chambers (4) are separated from one another by liquid-tight bottom plates,

each chamber is connected via a liquid overflow (6) to the chamber (4) located immediately underneath and a liquid product stream is taken off via the liquid overflow (6) of the bottommost chamber (4),

the gas space (7) above the liquid surface in each chamber (4) is connected to the chamber (4) located immediately above it by one or more guide tubes (8) which opens (each open) into a gas distributor (9) provided with openings for exit of gas below the liquid surface,

and each chamber is provided with at least one guide plate (12) which is arranged vertically around each siphon like gas distributor (9) and whose upper end is below the liquid surface and whose lower end is above the liquid-tight bottom plate (5) of the chamber (4) and which divides each chamber (4) into one or more spaces into which gas flows (13) and one or more spaces into which gas does not flow (14),

is used for gas/liquid or gas/liquid/solid reactions.

The invention relates to a reactor for gas/liquid or gas/liquid/solid reactions and also to its use.

In multiphase reactions, good mixing of the phases is a prerequisite for a high degree of conversion. Stirred vessels are frequently used for this purpose. However, stirred vessels have the disadvantage that they require moving parts and that the stirred vessel has to have a very large volume for carrying out slow equilibrium reactions which are to be brought to a high final conversion and in which a coproduct is stripped out continuously as vapor. Cascades of stirred vessels are known for carrying out such reactions, but these have the disadvantage that a correspondingly large number of individual apparatuses is necessary.

Carrying out multiphase reactions in reactive distillation columns is also known. However, the liquid hold-up on the trays is limited here. Particularly in the case of slow equilibrium reactions, the liquid hold-up would have to be so large that the gas-side pressure drops across the trays become very large. As a result, a large temperature spread becomes establishes over a plurality of trays in the column, accompanied by very different reaction rates. In the case of sensitive products, this can lead to decomposition of or damage to the product in the lower section of the column, while the reaction ceases in the upper section because the temperature is too low.

It is an object of the invention to provide a reactor for gas/liquid or gas/liquid/solid reactions which even at high residence times of the liquid or liquid/solid phase ensures a substantial approscination to the thermodynamic gas/liquid equilibrium as a result of very good phase mixing and, after mixing and reaction have occurred, substantial separation of gaseous and liquid phases.

Furthermore, the reactor should be able to be operated with a very small pressure drop for the ascending gas phase.

The achievement of this object starts out from a reactor for gas/liquid or gas/liquid/solid reactions having a vertical longitudinal axis and inlets for a liquid or liquid/solid feed stream in the upper region of the reactor and for a gaseous stream in the lower region of the reactor.

According to the present invention,

the reactor is provided with at least two chambers arranged above one another in the longitudinal direction, where

the chambers are separated from one another by liquid-tight bottom plates,

each chamber is connected via a liquid overflow to the chamber located immediately underneath and a liquid product stream is taken off via the liquid overflow of the bottommost chamber,

the gas space above the liquid surface in each chamber is connected to the chamber located immediately above it by one or more guide tubes which opens (each open) into a gas distributor provided with openings for exit of gas below the liquid surface,

and each chamber is provided with at least one guide plate which is arranged vertically around each gas distributor and whose upper end is below the liquid surface and whose lower end is above the liquid-tight bottom plate of the chamber and which divides each chamber into one or more spaces into which gas flows and one or more spaces into which gas does not flow.

We have thus found an apparatus which ensures excellent mixing of phases in multiphase reactions and a virtually constant composition of the reaction mixture over the total volume in each chamber, i.e. both over its cross section and also, in particular, over the height of the liquid, with, at the same time, simple separation of liquid and gaseous phases after the reaction is complete without use of moving parts by means of air-lift circulation of the liquid. The exit of the gas from the gas distributor into the liquid space between gas distributor and the guide plate or plates arranged vertically around the gas distributor reduces the hydrostatic pressure in this liquid space relative to the liquid space through which gas does not flow, resulting in a pressure gradient which is converted into kinetic energy. This pressure gradient drives the air-lift circulation in the form of a flow which is directed upward in the space through which gas flows, i.e. in the space between the gas distributor and the guide plate (plates) arranged around the gas distributor(s), is deflected by the guide plate (plates) in the region between the uppermost end of the guide plate (plates) and below the liquid surface, flows through the liquid space through which gas does not flow above the guide plate (plates) from the top downward and above the liquid-tight bottom plate of the chamber and below the bottommost end of the guide plate (plates) is once again deflected into an upward directed flow, thus closing the loop. The reactor of the present invention is an apparatus having a vertical longitudinal axis, i.e. an upright apparatus, and having an inlet for a liquid or liquid/solid feed stream in its upper region and an inlet for a gaseous stream (starting material and/or inert gas) in its lower region, i.e. with the liquid or liquid/solid stream and the gaseous stream being conveyed in countercurrent.

The reactor is made up of a plurality of chambers, in particular from 2 to 200 chambers, particularly preferably from 3 to 50 chambers arranged one above the other.

The geometry of the reactor is frequently cylindrical, but other geometries, in particular a cuboidal geometry, are also possible.

The chambers are separated from one another by liquid-tight bottom plates, with each chamber being connected via a liquid overflow to the chamber located immediately underneath. The liquid overflow can be configured, for example, in the form of a tube or a shaft and can be located either within the reactor or outside the reactor. In particular, the liquid overflows of two superposed chambers can be located on opposite sides of the reactor. A liquid product stream is taken off from the bottommost chamber via its liquid overflow.

The gas space above the liquid surface in each chamber is connected to the chamber located directly above it by one or more guide tubes which opens (each open) into a gas distributor with openings for exit of gas below the liquid surface. There are in principle no restrictions with regard to the number and arrangement of the guide tubes: it is equally possible to provide a single central guide tube or a plurality of guide tubes distributed over the cross section of the reactor. It is likewise possible to provide a plurality of separate gas distributors each supplied with gas via one or more guide tubes for each chamber instead of a single gas distributor. A gaseous stream is introduced from outside the reactor into the gas distributor of the bottommost chamber of the reactor via one or more guide tubes.

It is thus equally possible to provide a single gas distributor supplied with gas via one or more guide tubes or a plurality of gas distributors which are not interconnected and are each supplied with gas via one or more guide tubes.

In a preferred embodiment the liquid overflow in each chamber is disposed below the upper end of the gas supply tube (tubes) for the gas supply. This embodiment assures a static barrier, which prevents the flow away of liquid via the gas supply tube (tubes) into the chamber situated below.

There are in principle no restrictions with regard to the gas distributors which can be used for the purposes of the present invention: the important thing is that the gas distributor allows the gas supplied to it via the guide tube or tubes to exit from the gas space of the chamber located immediately underneath below the liquid surface of the chamber in which the gas distributor is located. The gas should preferably exit very uniformly. As gas distributor, it is in principle possible to use any commercial gas introduction device, for example gas distributors in the form of tubes which are equipped with openings for exit of the gas and may be, for example, arranged horizontally, i.e. in a plane parallel to the liquid-tight bottom plate of the chamber. It is also possible to provide ring-shaped gas distributors. However, the openings for the exit of gas always have to be located below the liquid surface in the chamber, preferably at a distance from the liquid surface of about 10% of the total height of liquid in the chamber, preferably of about 30%, particularly preferably of about 50%. It has been found that a particularly favorable immersion depth of the openings for the exit of gas below the liquid surface in the chamber is at least 50 mm. The openings for exit of gas are passed only by the gas that is only by one phase.

The lower end of the gas distributor is preferably placed apart from the bottom of the chamber, which means that the gas distributor is not completely dived into the liquid. Despite this fact, due to the airlift-effect, an excellent mixing of the liquid is assured.

The openings for exit of gas in the gas distributor are preferably placed apart from the bottom of the chamber, preferably by 40% to 90% of the liquid height in the chamber, measured from the bottom of the chamber to the liquid overflow.

The openings for exit of gas are placed in a preferred embodiment below the upper end of the gas supply tube. By this special constructive embodiment a siphon like barrier effect against the flow down of liquid via the gas supply tube is provided.

In a preferred variant, the gas distributor (distributors) has (have) a siphon-like configuration in the form of a hood which is closed at the top and has openings for the exit of gas in its lower part.

The hood can be completely closed except for the openings for the guide tube or tubes for supply of gas and the openings for exit of gas in its lower part.

It is likewise possible for the hood to be open in its lower part.

The upper closed end of the hood can be below the liquid surface, but it can also extend above the liquid surface into the gas space.

The hood of the siphon like gas distributor can in principle have any geometric shape; it is possible, for example, for it to comprise a plurality of parts which are connected to one another and are in cross section preferably arranged in the form of a cross and/or parallel or concentrically or radially.

The number, cross section and distance from the liquid surface in the chamber of the openings for the exit of gas are preferably such that the pressure drop experienced by the gaseous stream in the gas distributor is in the range from 0.1 to 50 mbar.

The openings of the gas distributor are preferably located at the same height relative to one another.

They can in principle have any geometric shape, for example circular, triangular or in the form of slots.

The central line of the openings is preferably at a distance of from about 1 cm to 15 cm from the lower end of the hood. Alternatively, it is also possible for the lower end of the hood to be provided with a zigzag edge instead of openings. In a further alternative, it is possible for the lower end of the hood to be in the form of a ring distributor.

Arrangement of the openings at different heights relative to one another can be advantageous in the case of operation with two or more loading regions.

The height of the openings for the exit of gas is chosen as required depending on the specific reaction to be carried out in the reactor so that, firstly, a sufficient mass transfer area is available for the specific gas/liquid or gas/liquid/solid reaction, and, secondly, sufficient impetus for the air-lift circulation of the liquid is made available.

Around each gas distributor in the reactor of the present invention, there is arranged at least one vertical guide plate whose upper end is below the liquid surface in the chamber, which is at a distance from the bottom plate of the chamber and which divides each chamber into one or more spaces into which gas flows and one or more spaces into which gas does not flow.

The guide plate can, in a preferred embodiment, be formed as a push-in tube having the shape of a hollow cylinder. However, it is also possible, for example, for it to have the shape of a simple flat plate.

The guide plate or plates is at a distance from the liquid surface and from the bottom plate of the chamber, preferably so that substantially no throttling of the liquid flow by the guide plate occurs. The distances of the guide plate or plates from the liquid surface and from the bottom plate of the chamber are thus preferably selected so that the flow velocity of the liquid is not altered or altered only slightly by the deflection caused by the guide plate.

The total height of the guide plate is in principle subject to no restrictions. It can be dimensioned appropriately, in particular as a function of the desired residence time per chamber while at the same time ensuring sufficient mixing.

In a preferred embodiment, a solid catalyst can be installed in one or more, preferably in all, chambers of the reactor, in particular as a bed of solid particles or in the form of catalyst-coated ordered packing, for example monoliths.

Furthermore, installation of an ion exchange resin in one or more, preferably in all, chambers is preferred.

The reactor of the present invention thus has the advantage that it ensures a very good mixing of the liquid phase in gas/liquid or gas/liquid/solid reactions and also ensures separation of the gaseous phase. Since it is only necessary for the gas to exit from the gas distributor below the liquid surface in the chamber for the air-lift circulation to function, with the distance of the gas outlet to the liquid surface being able, in principle, to vary within very wide limits, the reactor of the present invention provides an apparatus in which residence time of the liquid and pressure drop of the gas are largely decoupled, especially if the diving is small.

It is particularly advantageous for carrying out slow equilibrium reactions which are to be brought to a high conversion, frequently from 90 to 99.9%. Furthermore, the reactor of the present invention makes it possible to set a very wide range for the liquid hold-up per tray (bottom plate of a chamber) and thus makes it possible to set a very wide residence time range from a few minutes to a number of hours.

The reactor is particularly useful for carrying out gas/liquid or gas/liquid/solid reactions in which it is not only the mass transfer area which represents the rate-limiting step. It is also suitable for continuous reactions which are first order or higher and are to be brought to a high degree of conversion, for example the reaction of propylene oxide with carbon dioxide to form propylene carbonate and for hydrogenations, for example for color number hydrogenations.

The reactor of the present invention is especially useful for carrying out equilibrium reactions which are to be brought to a high conversion and in which a coproduct is continuously removed as vapor from the reaction mixture by means of inert gas or by means of one of the reactants so as to shift the reaction equilibrium in the desired direction. Examples of such reactions are esterifications, for example the esterification of phthalic acid or phthalic anhydride with alcohols to form phthalic esters which are preferably employed as plasticisers or the esterification of adipic acid or acrylic acid with alcohols to form their esters. A characteristic of all these reactions is that the water formed is removed continuously from the reaction mixture by means of a countercurrent of inert gas or preferably a countercurrent of alcohol vapor for the purpose of shifting the reaction equilibrium. Further examples are transesterification reactions, in particular the transesterification of polytetrahydrofuran having terminal acyl groups in the presence of lower alcohols, preferably methanol, to produce polytetrahydrofuran having terminal hydroxyl groups.

The invention is illustrated below with the aid of a figure and an example: In the drawing:

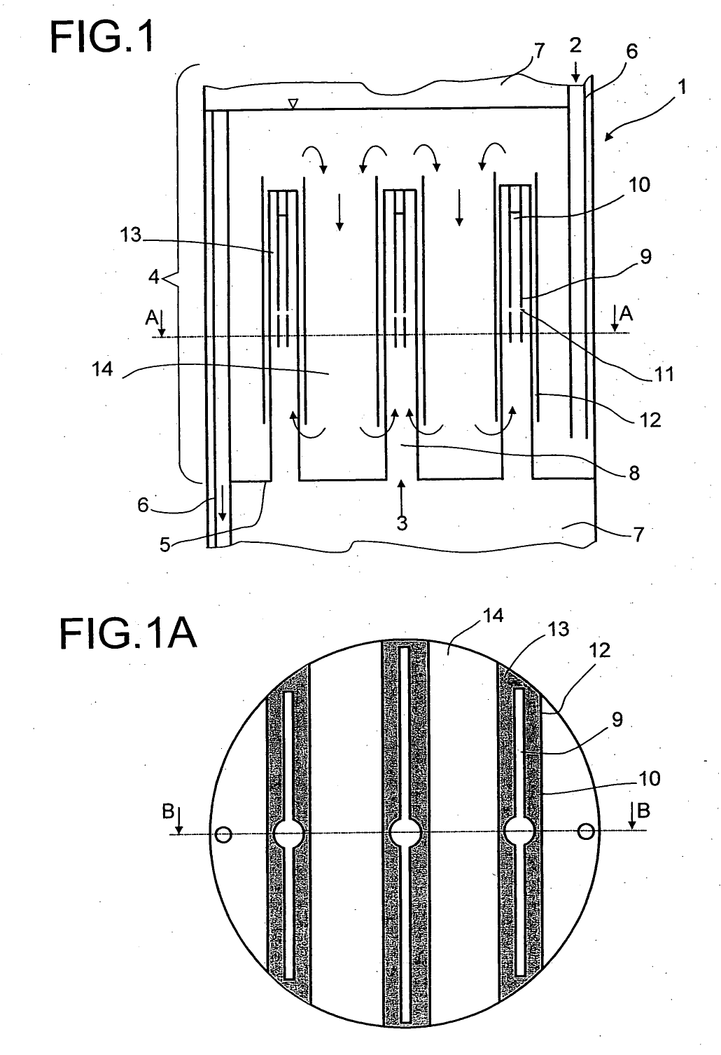

FIG. 1 shows a longitudinal section through a first embodiment of a chamber of a reactor according to the present invention, with cross section in FIG. 1a and

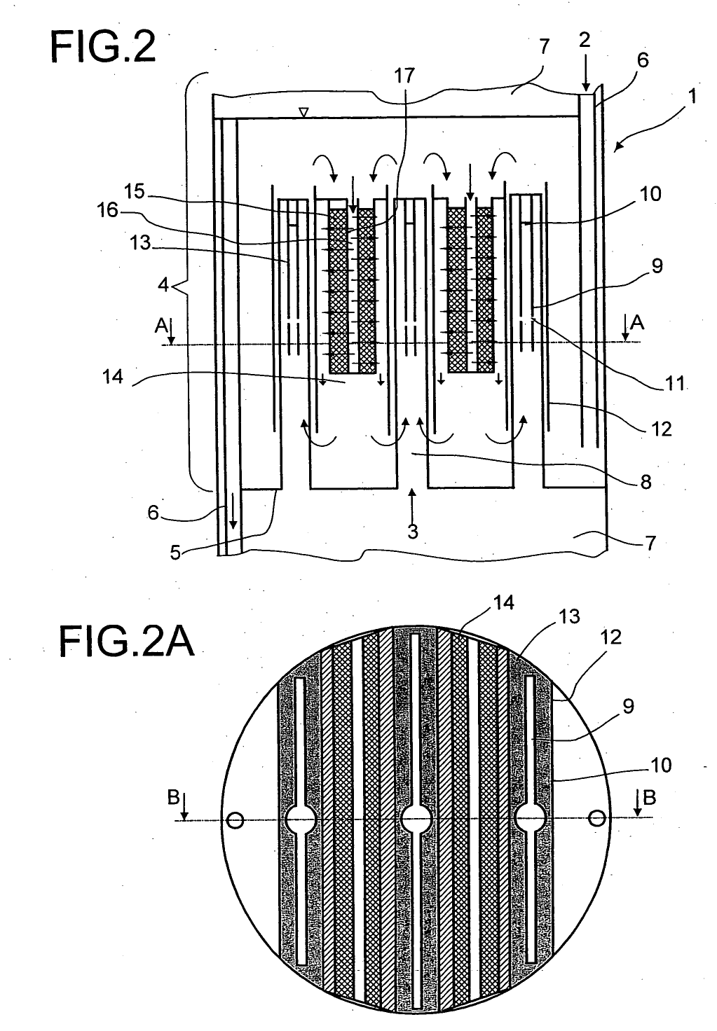

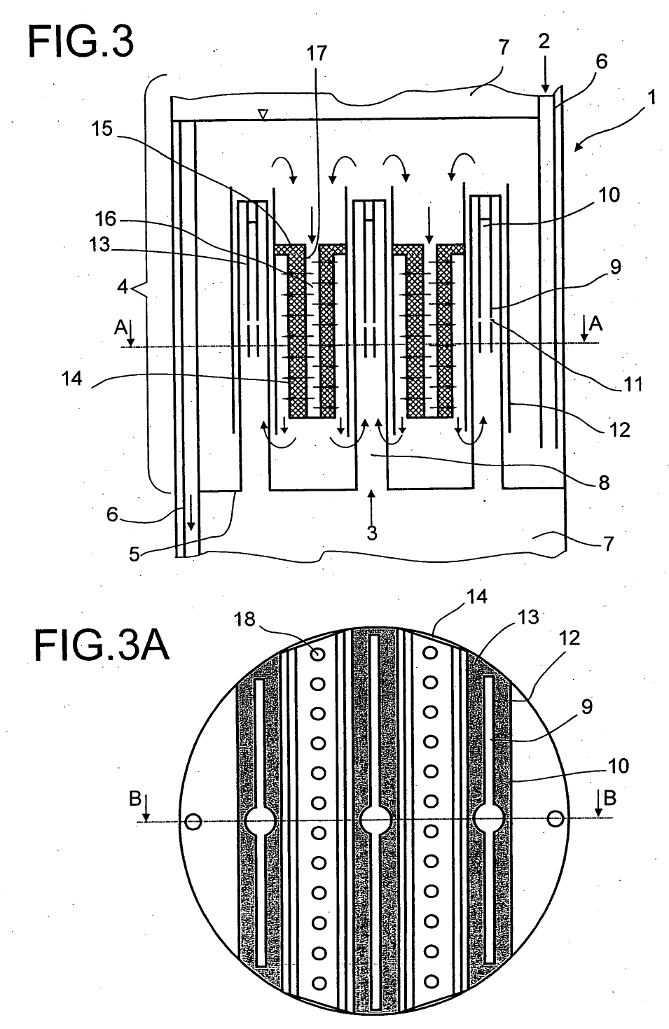

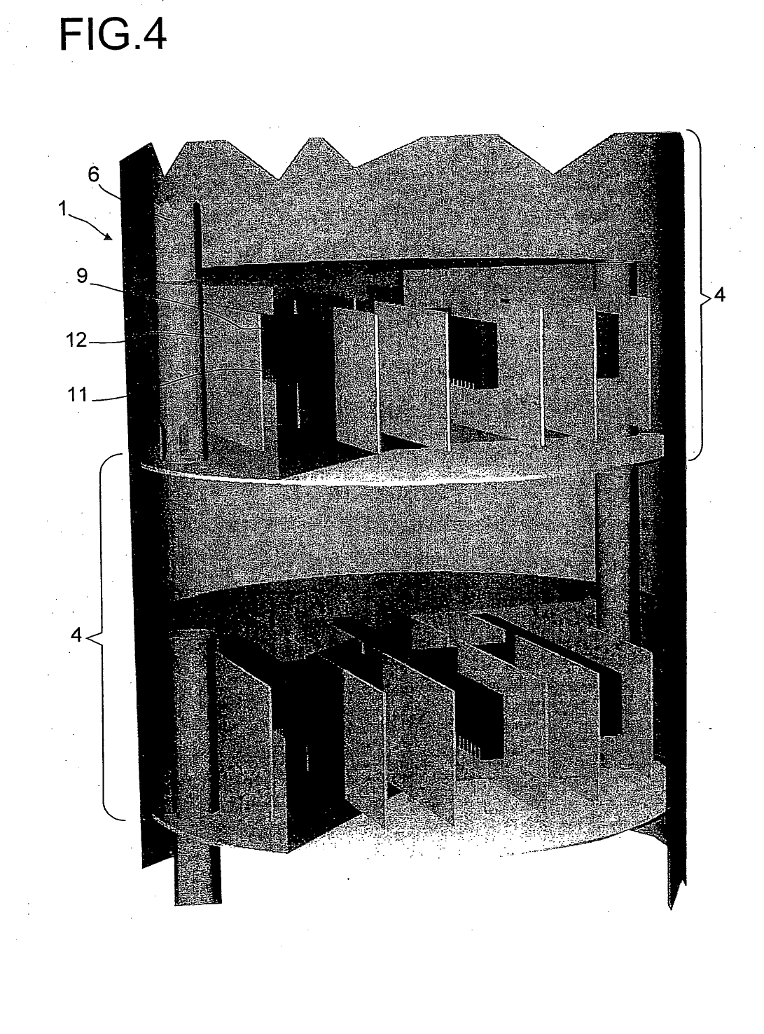

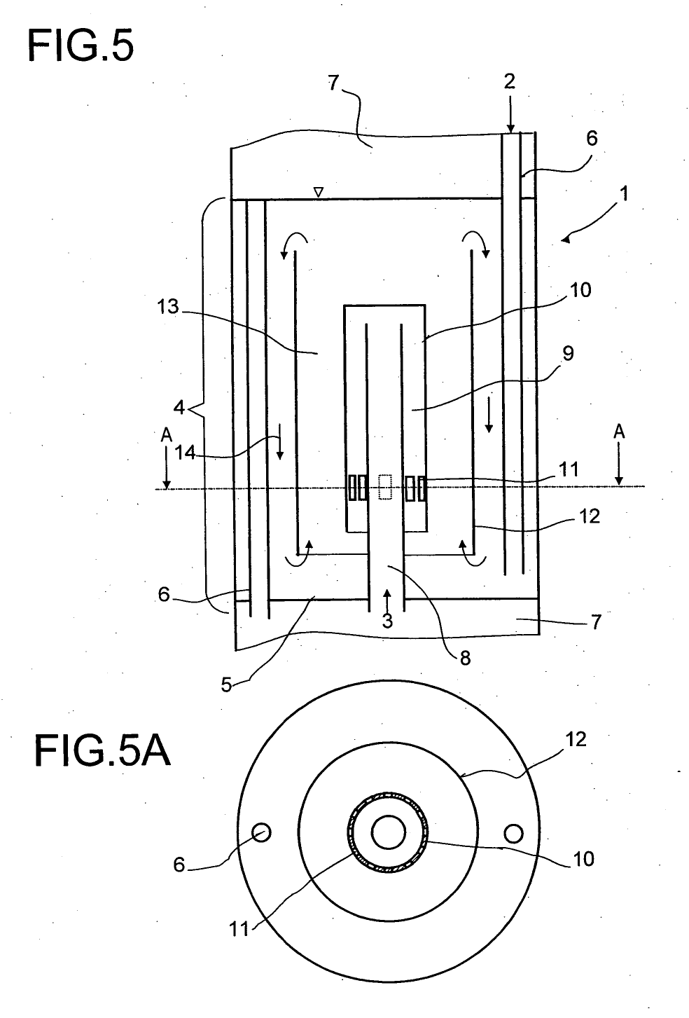

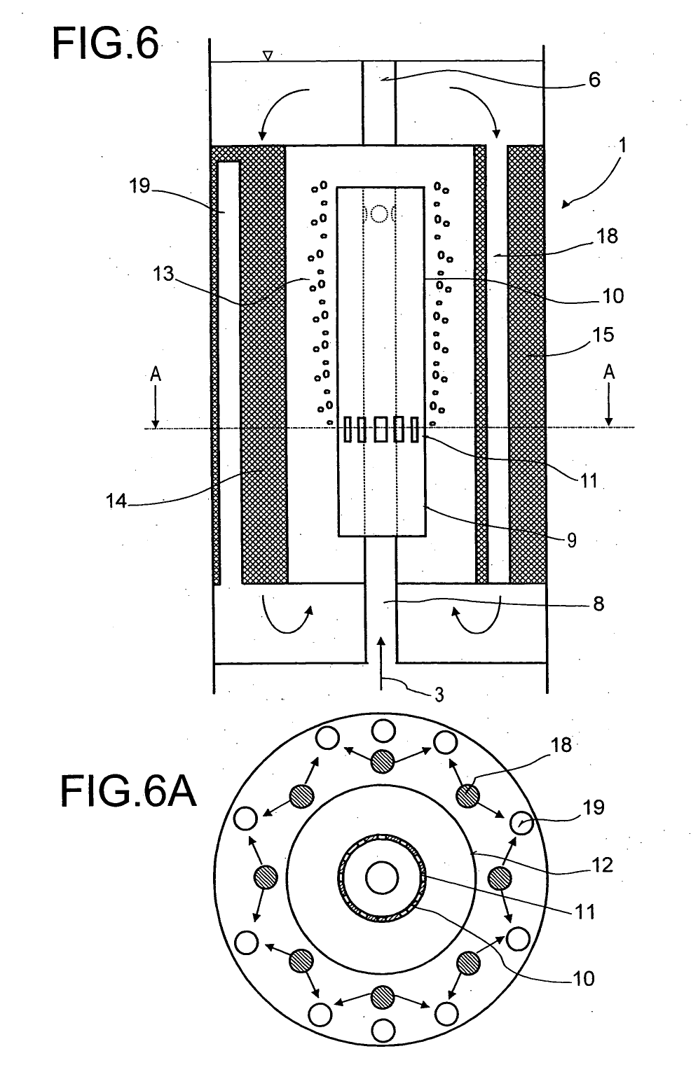

FIG. 2 shows a longitudinal section through a chamber of a second embodiment of a reactor according to the present invention, with cross section in FIG. 2a.

FIG. 1 shows, by way of example, one of two or more chambers 4 located above one another in the longitudinal direction in a reactor 1 with inlet 2 for a liquid or liquid/solid feed stream in the upper region and an inlet 3 for a gaseous stream in the lower region of the reactor 1, with each chamber 4 being provided with a bottom plate 5, liquid overflows 6 which are shown, by way of example, in the interior of the reactor 1, and a gas space 7 above the liquid surface in each chamber 4 which is connected, by way of example, via a guide tube 8 to the chamber 4 located above it and opens into a siphon-like gas distributor 9 in the form of a hood 10 closed at the top and having openings 11 for the exit of gas in its lower part. Around the siphon-like gas distributor 9, there are arranged guide plates 12 which are at a distance from the liquid surface and from the bottom plate of the chamber 4 and divide the chamber 4 into a plurality of spaces 13 into which gas flows and a plurality of spaces 14 into which gas does not flow.

The cross-sectional depiction in FIG. 1a shows the shape of the hood 10 of the gas distributor 9, in the present case, by way of example, made up of parts arranged in the shape of a cross and parts arranged in parallel.

In the longitudinal section of a further illustrative embodiment in FIG. 2, the same reference numerals refer to the same features as in FIG. 1.

The cross-sectional depiction in FIG. 2a shows the radial (as an example) arrangement of the parts of the hood 10 of the siphon like gas distributor 9.

### EXAMPLE

Three parts by weight of polytetrahydrofuran diacetate having a mean molecular weight of 1 880 were mixed in the form of a melt with 2 parts by weight of methanol in a mixing section and heated to 65° C. 300 ppm by weight of a methanolic sodium methoxide solution were added as catalyst and the mixture was introduced into the uppermost chamber of a reactor according to the present invention having 10 chambers and reacted. A stream of methanol vapor corresponding to 0.3 kg per kg of polytetrahydrofuran diacetate used were introduced in countercurrent into the bottommost chamber to strip out the coproduct methyl acetate. A conversion of about 96% was achieved just in the uppermost chamber.

The further removal of methyl acetate from the reaction solution together with the associated further transesterification reaction occurred in the chambers located further down in the reactor of the present invention. The liquid reaction mixture from each chamber was passed via liquid overflows into the next chamber underneath, with mean residence times of 14 min in each chamber.

In the bottommost chamber, the methyl acetate was removed from the reaction solution down to a residual content of <0.1% by weight. The methanol vapor ascending in countercurrent to the reaction liquid became increasingly enriched in methyl acetate from chamber to chamber, while the methyl acetate contents of the liquid phase in the chambers decreased correspondingly from the top to the bottom. As a result of the reduction of the methyl acetate contents at a residence time of 15 min per chamber, a conversion of the polytetrahydrofuran diacetate used of 99.9% was achieved in the last, bottommost chamber.

The height of liquid in each chamber was 25 cm. Each chamber was provided with a gas distributor having openings for the exit of gas at a distance of 10 cm below the liquid surface. Owing to this small hydrostatic pressure difference, there was only a small temperature spread, from abut 65 to about 68° C., over the height of the boiling liquid reaction mixture in each chamber. As a result, no coloring components and thus an excellent product quality were obtained.

The gas distributors were each located within a push-in tube which was located at a distance from the liquid surface and from the bottom plate of the chamber and divided the chamber into a space into which gas flowed and a space into which gas did not flow in a cross-sectional area ratio of 60:40. As a result of the good mixing in the chambers, the enrichment of the methanol vapor with methyl acetate reached about 85-95% of the vapor/liquid equilibrium.

### Comparative example

For comparison, the same transesterification reaction was carried out in a four-stage cascade of stirred tanks. This required a mean residence time of about 8 hours compared to the total residence time of 2.5 hours for the process in the reactor of the present invention. Stripping of the coproduct methyl acetate required from 0.8 to 0.9 kg of methanol vapor per kg of polytetrahydrofuran diacetate used, i.e. about three times the amount of methanol vapor required for the process in the reactor of the present invention.

We claim:

1. A reactor (1) for gas/liquid or gas/liquid/solid reactions having a vertical longitudinal axis and an inlet (2) for a liquid or liquid/solid feed stream in the upper region of the reactor and an inlet (3) for a gaseous stream in the lower region of the reactor (1), characterized by
at least two chambers (4) arranged above one another in the longitudinal direction, where
the chambers (4) are separated from one another by liquid-tight bottom plates (5),
each chamber (4) is connected via a liquid overflow (6) to the chamber (4) located immediately underneath and a liquid product stream is taken off via the liquid overflow (6) of the bottommost chamber (4),
the gas space (7) above the liquid surface in each chamber (4) is connected to the chamber (4) located immediately above it by one or more guide tubes (8) which opens (each open) into a gas distributor (9) provided with openings (11) for exit of gas below the liquid surface, wherein the openings (11) of the gas distributor (9) for exit of gas are spaced apart from the bottom plate (5) of the chamber (4), for 40% to 90% of the liquid height in the chamber (4), measured from the bottom plate (5) of the chamber (4) to the liquid overflow,
and each chamber is provided with at least one guide plate (12) which is arranged vertically around each gas distributor (9) and whose upper end is below the liquid surface and whose lower end is above the liquid-tight bottom plate (5) of the chamber (4) and which divides each chamber (4) into one or more spaces into which gas flows (13) and one or more spaces into which gas does not flow (14).

2. A reactor (1) as claimed in claim 1, wherein the openings (11) of the gas distributor (9) for exit of gas are situated below the upper end of the gas supply tube (8).

3. A reactor (1) as claimed in claim 1 or 2, wherein the gas distributor (9) has a siphon like configuration in the form of a hood (10) closed to the top.

4. A reactor (1) as claimed in claim 3, wherein the hood of the siphon like gas distributor is open in its lower part.

5. A reactor (1) as claimed in claim 3 or 4, wherein the hood(s) (10) of the siphon like gas distributor(s) (9) is (are) made up of two or more parts which are connected to one another and, in cross section, are arranged in the form of a cross and/or parallel or concentrically or radially.

6. A reactor (1) as claimed in any of claims 1 to 5, wherein the number and size of the openings (11) for the exit of gas and their distance from the liquid surface in the chamber (4) are selected so that the pressure drop of the gaseous stream in the gas distributor (9) is in the range from 0.1 to 50 mbar, preferably from 0.5 to 10 mbar.

7. A reactor (1) as claimed in any of claims 1 to 6, wherein the openings (11) for the exit of gas are each located at the same height relative to one another.

8. A reactor (1) as claimed in any of claims 3 to 7, wherein the openings (11) for the exit of gas are located in the lower part of the hood(s) (10) at a distance of from 1 to 15 cm from the lower end of the hood(s) (10).

9. A reactor (1) as claimed in any of claims 1 to 8, wherein the guide plate(s) is (are each) at such distance from the liquid surface and from the bottom plate of the chamber (4) that substantially no throttling of the liquid flow by the guide plate(s) (12) occurs.

10. A reactor (1) as claimed in any of claims 1 to 9, wherein at least one guide plate (12) arranged vertically around each gas distributor (9) is in the form of a push-in tube.

11. A reactor (1) as claimed in any of claims 1 to 10, wherein the guide plate(s) and the gas distributor(s) (9) is (are) arranged in such a way that the cross-sectional area through which gas does not flow is in the range of from 10 to 80%, preferably from 40 to 60%, particularly preferably 50%, of the sum of the cross sectional areas through which gas flows and through which gas does not flow.

12. A reactor (1) as claimed in any of claims 1 to 11, wherein the liquid-tight bottom plates (5) and/or the gas distributors (9) and/or the guide plates (12) are configured as heat exchanger plates.

13. A reactor (1) as claimed in any of claims 1 to 12, wherein one or more, chambers (4) are provided in the spaces through which gas does not flow (14) with inserts (15) for accommodating catalyst bodies, with one or more vertical, preferably symmetrically arranged drainage shafts (16) whose sides are permeable to liquid and which are open at the top and closed at the bottom, and with liquid-permeable walls (17) in the region of the guide plates (12).

14. A reactor (1) as claimed in claim 13, wherein vertical perforated tubes (18) which are open at the top and closed at the bottom are provided in place of the drainage shafts (16).

15. A process for carrying out gas/liquid/solid reactions in a reactor (1) as claimed in any of claims 1 to 14, wherein a solid catalyst is installed in one ore more, preferably in all, chambers (4) of the reactor (1) in the spaces through which gas does not flow (14), in particular as a bed of solid particles and/or of in the form of catalyst-coated ordered packing or as a catalyst coated monolith.

16. A process for carrying out gas/liquid/solid reactions in a reactor (1) as claimed in any of claims 1 to 12, wherein a suspended solid catalyst is installed in one or more, preferably in all, chambers (4) through which gas does not flow in the reactor (1).

17. A process for carrying out gas/liquid/solid reactions in a reactor (1) as claimed in any of claims 1 to 18, wherein an ion exchange resin is installed in one or more, preferably in all, chambers (4) through which gas does not flow.

18. The use of a reactor (1) as claimed in any of claims 1 to 14 or a process as claimed in any of claims 15 to 17 for carrying out equilibrium reactions, in particular transesterficatons of polyetrahydrofuran containing acyloxy end groups, esterfications, in particular of phthalic acid with higher alcohols, etherfications, rearrangements, hydrolyses and hemiacetal formation reactions.

19. The use as claimed in claim 18, wherein a reactor in which the reactants are present as a single phase is installed upstream.
